(19) United States
(12) Patent Application Publication
(10) Pub. No.: US 2010/0000489 A1
(43) Pub. Date: Jan. 7, 2010

(54) INTEGRATED VALVE DEVICE FOR INTAKE MANIFOLD

(75) Inventors: Kazuyuki OTAKI, Kariya-shi (JP); Yuko INAGAKI, Kariya-shi (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/488,856

(22) Filed: Jun. 22, 2009

(30) Foreign Application Priority Data
Jul. 4, 2008 (JP) 2008-175864

(51) Int. Cl. F02M 35/10

(52) U.S. Cl. 123/184.56

(57) ABSTRACT

An integrated valve device for an intake manifold includes a casing having intake passages each connected to an intake port of an internal combustion engine and a through hole extending perpendicular to the intake passages. A valve shaft is received in the through hole. The valve shaft includes valve portions. Each valve portion is arranged to correspond to one of the intake passages. The valve portions are switchable between a first position, where each valve portion fully opens the corresponding intake passage, and a second position, where each valve portion partly blocks the corresponding intake passage. A recess may be formed in a wall defining each intake passage. In this case, when in the first position, each valve portion is entirely accommodated in the corresponding recess. When in the second position, each valve portion projects from the corresponding recess.

### BACKGROUND OF THE INVENTION

The present invention relates to a valve device that controls intake flow in an intake manifold by using a valve shaft having a shaft portion and valve portions supported by the shaft portion to be rotatable integrally with the shaft portion, thereby promoting occurrence of tumble flow in a combustion chamber of an internal combustion engine.

Conventionally, an intake air controlling apparatus having a rotary valve is known, in which the rotary valve has valve portions and is located in the intake manifold of an internal combustion engine such as an automobile engine. For example, the rotary valve disclosed in Japanese Laid-Open Patent Publication No. 2005-113873 (for example, refer to ABSTRACT and FIG. 1) switches the length of the path in the intake manifold between two lengths depending on whether the internal combustion engine is in a low speed range or a high speed range.

The multiple integral valve device disclosed in Japanese Laid-Open Patent Publication No. 2008-45430 (for example, refer to FIGS. 2 and 3) has valve portions, which are skewered with a shaft having a polygonal cross-sectional shape. Each valve portion is arranged to correspond to one of intake passages. By integrally rotating with the shaft, each valve portion selectively opens and closes the corresponding intake passage. Each valve portion has a slit, which is formed by partially cutting out the distal end thereof. The intake flow passing through the slit promotes the occurrence of tumble flow in the combustion chambers of the internal combustion engine. However, in addition to the fact that the number of components of the multiple integral valve device is disadvantageously great, skewering the valve portions with the shaft increases the number of steps for manufacturing the device.

### SUMMARY OF THE INVENTION

Accordingly, it is an objective of the present invention to reduce the number of components and the number of manufacturing steps of a valve device of an intake manifold, which device is capable of promoting the occurrence of tumble flow in the combustion chambers of an internal combustion engine.

To achieve the foregoing objective and in accordance with one aspect of the present invention, an integrated valve device for an intake manifold is provided. The device includes a casing and a valve shaft. The casing has a plurality of intake passages each connected to an intake port of an internal combustion engine and a through hole extending perpendicular to the intake passages. The valve shaft is received in the through hole. The valve shaft includes a plurality of valve portions. Each valve portion is arranged to correspond to one of the intake passages. The valve portions are switchable between a first position, where each valve portion fully opens the corresponding intake passage, and a second position, where each valve portion partly blocks the corresponding intake passage.

In a preferred embodiment, a recess is formed in a wall defining each intake passage. When in the first position, each valve portion is entirely accommodated in the corresponding recess. When in the second position, each valve portion projects from the corresponding recess.

In a preferred embodiment, the valve shaft has a shaft portion. By rotating integrally with the shaft portion, the valve portions are switched between the first position and the second position.

In a preferred embodiment, the valve shaft has partitioning portions located on both sides of each valve portion. Each valve portion may be integrally formed with the partitioning portions on the sides thereof. Further, each valve portion and the partitioning portions on the sides thereof may be integrally formed of synthetic resin. Alternatively, the partitioning portions may be supported by the shaft portion to be rotatable about the shaft portion.

In a preferred embodiment, each valve portion has an arcuate surface portion. When the valve portions are in the second position, the arcuate surface portion of each valve portion faces upstream in the corresponding intake passage.

In a preferred embodiment, each valve portion has a flat surface portion. When the valve portions are in the first position, the flat surface portion of each valve portion is flush with the wall in the corresponding intake passage.

In a preferred embodiment, each valve portion has an outer shape defined by two intersecting flat surface portions and an arcuate surface portion connecting the flat surface portions to each other, and has a sectoral cross-sectional shape. When the valve portions are in the second position, the arcuate surface portion of each valve portion faces upstream in the corresponding intake passage. When the valve portions are in the first position, one of the flat surface portions of each valve portion is flush with the wall in the corresponding intake passage.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is an exploded perspective view illustrating an intake manifold having a valve device according to a first embodiment of the present invention;

FIG. 2 is a front view of the intake manifold of FIG. 1, showing a portion including a flange for connecting intake passages to intake ports of an engine;

FIG. 3A is a cross-sectional view taken along line A-A of FIG. 2, showing a state in which the valve portions are in a first position;

FIG. 3B is a cross-sectional view taken along line A-A of FIG. 2, showing a state in which the valve portions are in a second position;

FIG. 4A is a cross-sectional view taken along line B-B of FIG. 3A;

FIG. 4B is a cross-sectional view taken along line C-C of FIG. 3B;

FIG. 5 is a perspective view illustrating a valve shaft in a valve device according to a second embodiment of the present invention;

FIG. 6A is a cross-sectional view illustrating an intake manifold having the valve device of FIG. 5, showing a state in which the valve portions are in the first position;

FIG. 6B is a cross-sectional view illustrating an intake manifold having the valve device of FIG. 5, showing a state in which the valve portions are in the second position;

FIG. 6C is a cross-sectional view illustrating an intake manifold having the valve device of FIG. 5, showing a state in which the partitioning portions are fitted in a through hole of the intake manifold; and

FIG. 7 is a perspective view illustrating a casing of an intake manifold having the valve device of FIG. 5.

### DETAILED DESCRIPTION OF THE PREFERRED EMBODIMENTS

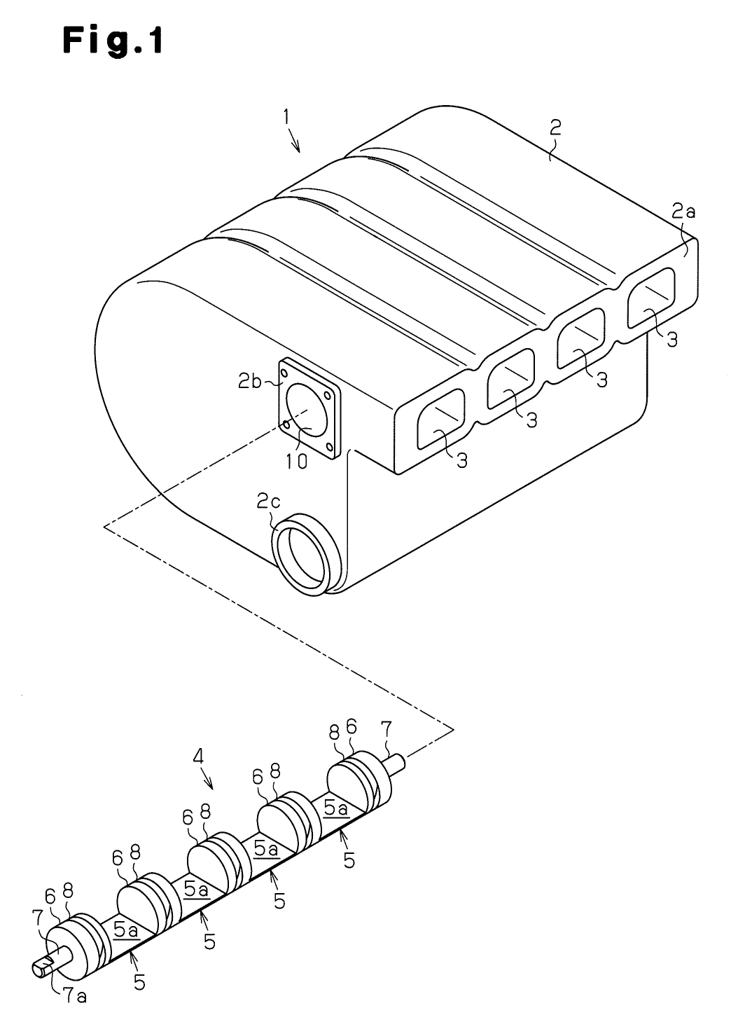

A first embodiment of the present invention will now be described with reference to FIGS. 1 to 4B.

FIG. 1 shows an intake manifold 1 having an integrated valve device according to the first embodiment. The intake manifold 1 includes a casing 2. Four intake passages 3 are formed to extend through the casing 2. The casing 2 has a connection portion 2a and a connection portion 2c. The connection portion 2a, which is a flange, connects each intake passage 3 to the intake port of one of four cylinders of an engine (not shown). The connection portion 2c connects the intake passages 3 to the clean side duct of an air cleaner (not shown). Air drawn into the intake manifold 1 through the connection portion 2c is first conducted to a surge tank chamber (not shown) in the casing 2. Paths branching from the surge tank chamber each connect the surge tank chamber with one of the intake passages 3. The casing 2 has a through hole 10 that extends perpendicular to the intake passages 3. The through hole 10 has a circular cross section.

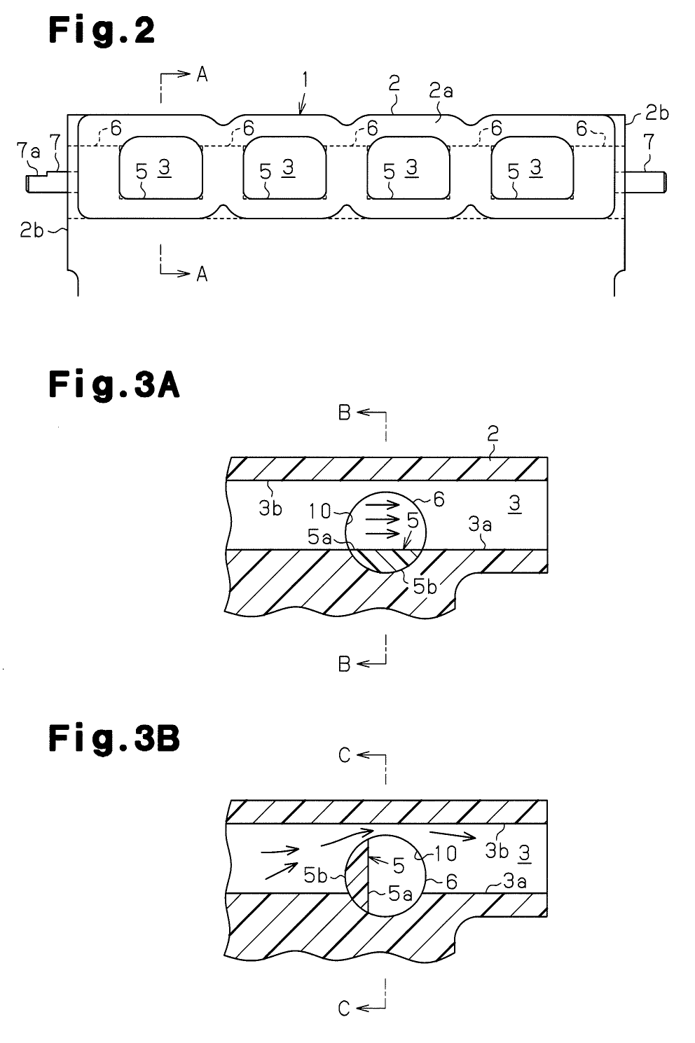

As shown in FIG. 3A, the through hole 10 intersects each intake passage 3 in a manner to extend through and communicate with the intake passage 3. In the through hole 10, a recess having an arcuate cross section is formed by partially gouging a floor 3a of each intake passage 3. The through hole 10 is separated from a roof 3b of each intake passage 3. As shown in FIGS. 1 and 2, a connection portion 2b is provided in a part of each side surface of the casing 2, which part corresponds to one of the ends of the through hole 10. An actuator and a bearing (neither is shown) are fixed to the two connection portions 2b, respectively.

A valve shaft 4 is received in the through hole 10. The valve shaft 4 has shaft portions 7 each arranged at one of the ends of the valve shaft 4. One of the shaft portions 7 has a distal end 7a shaped as a D-cut, which is coupled to the actuator. The other shaft portion 7 is rotatably supported by the bearing.

The casing 2 is formed by glass fiber reinforced polyamide. Instead of polyamide, engineering plastic may be used. The casing 2 is formed by integrating a plurality of components through welding, adhesion, or mechanical coupling with, for example, bolts.

The valve shaft 4 has four valve portions 5 having an arcuate cross section. Each valve portion 5 has an outer shape defined by a flat surface portion 5a and an arcuate surface portion 5b. A partitioning portion 6 having a circular cross section is provided on either side of each valve portion 5. The valve portions 5, the partitioning portions 6, and the shaft portions 7 are integrally formed of polyamide. Thus, the valve portions 5 and the partitioning portions 6 rotate integrally with the shaft portions 7. Instead of polyamide, other types of synthetic resin such as polyacetal and polyethylene may be used.

An annular groove is formed in the circumference of each partitioning portion 6, and an annular sealing member 8 is fitted in each of the grooves. Each sealing member 8 is made of self-lubricating synthetic resin. Each sealing member 8 has a rectangular cross section, and can be expanded radially. When the valve shaft 4 is received in the through hole 10, each sealing member 8 seals the space between the corresponding partitioning portion 6 and the wall defining the through hole 10.

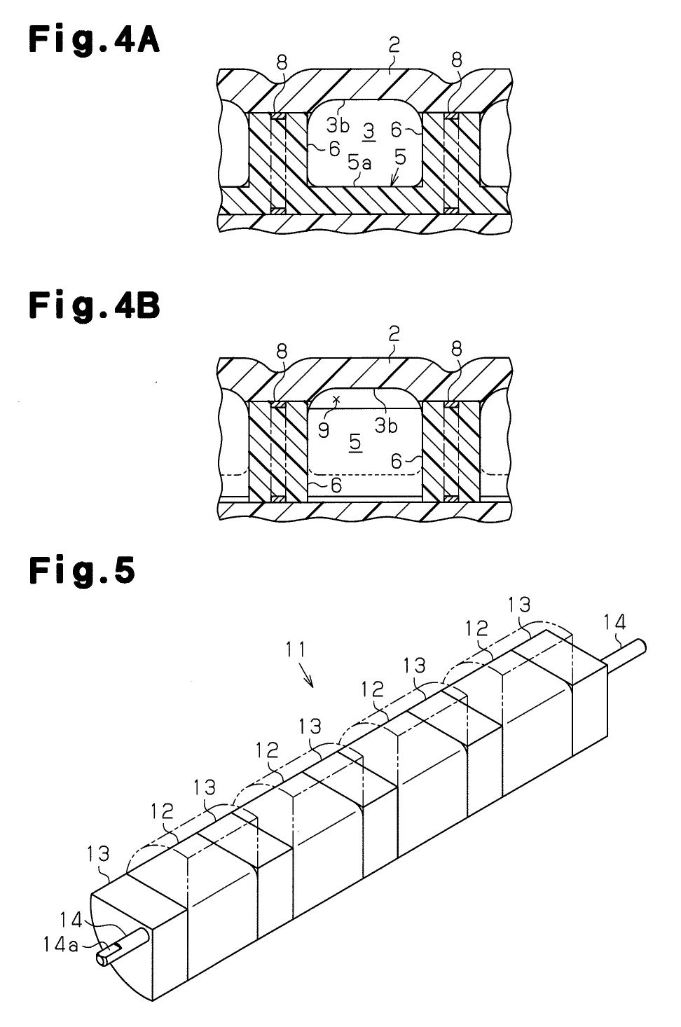

As shown in FIGS. 2 and 4A, the valve shaft 4 is received in the through hole 10 such that each of the five partitioning portion 6 is arranged at a portion of the through hole 10 that corresponds to a wall dividing an adjacent pair of the intake passages 3. That is, no part of each partitioning portion 6 projects into the corresponding intake passage 3. Therefore, when each valve portion 5 is entirely accommodated in the recess in the floor 3a of the corresponding intake passage 3, the intake flow in the intake passage 3 is not hindered by the valve shaft 4. That is, each intake passage 3 is fully open. Also, since the sealing member 8 is fitted in each partitioning portion 6, the intake flow in each intake passage 3 does not leak to the outside of the intake passage 3 through the through hole 10.

Referring to FIGS. 3A, 3B, 4A, and 4B, the operation will be described below in which the position of the valve portions 5 in the through hole 10 is switched by rotation of the valve shaft 4, so that the intake passages 3 are opened and closed.

In a first position shown in FIGS. 3A and 4A, each valve portion 5 is entirely accommodated in the recess in the floor 3a of the corresponding intake passage 3, such that the flat surface portion 5a of the valve portion 5 is flush with the floor 3a of the intake passage 3. At this time, the intake flow in each intake passage 3 is not hindered by the corresponding valve portion 5. That is, each intake passage 3 is fully open. When the valve shaft 4 is rotated clockwise from this state by 90°, most of each valve portion 5 projects from the recess of the floor 3a in the corresponding intake passage 3 as shown in FIGS. 3B and 4B, and the valve portions 5 are in a second position, in which each valve portion 5 partly closes the corresponding intake passage 3. In this state, the intake flow in each intake passage 3 is limited to a space 9 between the valve portion 5 and the roof 3b of the intake passage 3. As a result, the intake flow in each intake passage 3 then flows in the corresponding intake port of the engine along the roof of the intake port. This promotes the occurrence of tumble flow in the combustion chambers of the engine.

When the valve portions 5 are switched from the first position to the second position, the arcuate surface portion 5b of each valve portion 5 slides in the recess of the corresponding intake passage 3 such that the arcuate surface portion 5b faces upstream in the intake passage 3. Therefore, the intake flow in each intake passage 3 is smoothly guided to the space 9 by the arcuate surface portion 5b of the corresponding valve portion 5, which prevents the intake flow in each intake passage 3 from being disturbed.

For example, when there is no need to promote the occurrence of tumble flow in the combustion chambers, for example, when the engine is required to run at a high speed, the valve shaft 4 is rotated counterclockwise to switch the valve portions 5 from the second position to the first position. As a result, the intake passages 3 are fully open, and the engine runs at a high speed.

The first embodiment has the following advantages.

Each of the four valve portions 5 can be switched between the first position, where the valve portion 5 is entirely accommodated in the recess in the floor 3a of the corresponding intake passage 3 to fully open the intake passage 3, and the second position, where most of the valve portion 5 projects from the recess to partly block the intake passage 3. When the valve portions 5 are in the second position, the intake flow in each intake passage 3 is limited to the space 9 between the valve portion 5 and the roof 3b of the intake passage 3. As a result, the intake flow in each intake passage 3 then flows in the corresponding intake port of the engine along the roof of the intake port. This promotes the occurrence of tumble flow in the combustion chambers of the engine.

The valve portions 5, the partitioning portions 6, and the shaft portions 7 are integrally formed of a synthetic resin. This facilitates the insertion of the valve shaft 4 into the through hole 10 of the casing 2 and reduces the number of manufacturing steps of the valve device.

Since the valve portions 5 and the partitioning portions 6 are integrally formed, the relative positions of the valve portions 5 and the partitioning portions 6 are always the same. Thus, when the valve shaft 4 is received in the through hole 10, the valve portions 5 and the partitioning portions 6 are easily arranged at predetermined positions in the through hole 10. This reduces the number of steps for installing the valve shaft 4 to the intake manifold 1.

When the valve portions 5 are switched from the first position to the second position by rotation of the valve shaft 4, the arcuate surface portion 5b of each valve portion 5 slides in the recess of the corresponding intake passage 3 such that the arcuate surface portion 5b faces upstream in the intake passage 3. Therefore, the intake flow in each intake passage 3 is smoothly guided to the space 9 by the arcuate surface portion 5b of the corresponding valve portion 5, which prevents the intake flow in each intake passage 3 from being disturbed.

A second embodiment of the present invention will now be described with reference to FIGS. 5 to 7. An integrated valve device according to the second embodiment includes a valve shaft 11 and a through hole 15, which are different from the valve shaft 4 and the through hole 10 of the integrated valve device of the first embodiment. Other than these differences, the integrated valve device of the second embodiment is substantially the same as that of the first embodiment. Accordingly, mainly the differences of the present embodiment from the first embodiment will be discussed below.

As shown in FIGS. 5 to 7, the valve shaft 11 includes four synthetic resin valve portions 12, five synthetic resin partitioning portions 13, and a single metal shaft portion 14. The shaft portion 14 has an end 14a formed as a D-cut. The valve portions 12 are integrated with the shaft portion 14 through the insert molding, so that the valve portions 12 rotate integrally with the shaft portion 14. A partitioning portion 13 is located on either side of each of the valve portions 12, which are arranged at equal intervals. The partitioning portions 13 are supported by the shaft portion 14 to be rotatable about the shaft portion 14. Thus, the valve portions 12 and the shaft portion 14 rotate integrally with each other relative to the partitioning portions 13. Each partitioning portion 13 is formed, for example, by arranging a pair of half bodies with the shaft portion 14 in between and then joining the half bodies to each other.

Each valve portion 12 has an outer shape defined by two intersecting flat surface portions 12a, 12b and an arcuate surface portion 12c connecting the flat surface portions 12a, 12b to each other. Likewise, each partitioning portion 13 has an outer shape defined by two intersecting flat surface portions and an arcuate surface portion connecting the flat surface portions to each other. The valve portions 12 and the partitioning portions 13 have the same sectoral cross-sectional shape. In the present embodiment, the flat surface portions 12a, 12b of each valve portion 12 are perpendicular to each other. Also, the two flat surface portions of each partitioning portion 13 are perpendicular to each other. The corner defined by the flat surface portion 12a and the flat surface portion 12b of each valve portion 12 is chamfered, while the corner defined by the flat surface portions of each partitioning portion 13 is not chamfered. The through hole 15, which receives the valve shaft 11, has the same sectoral cross-sectional shape as the cross-sectional shape of the partitioning portions 13.

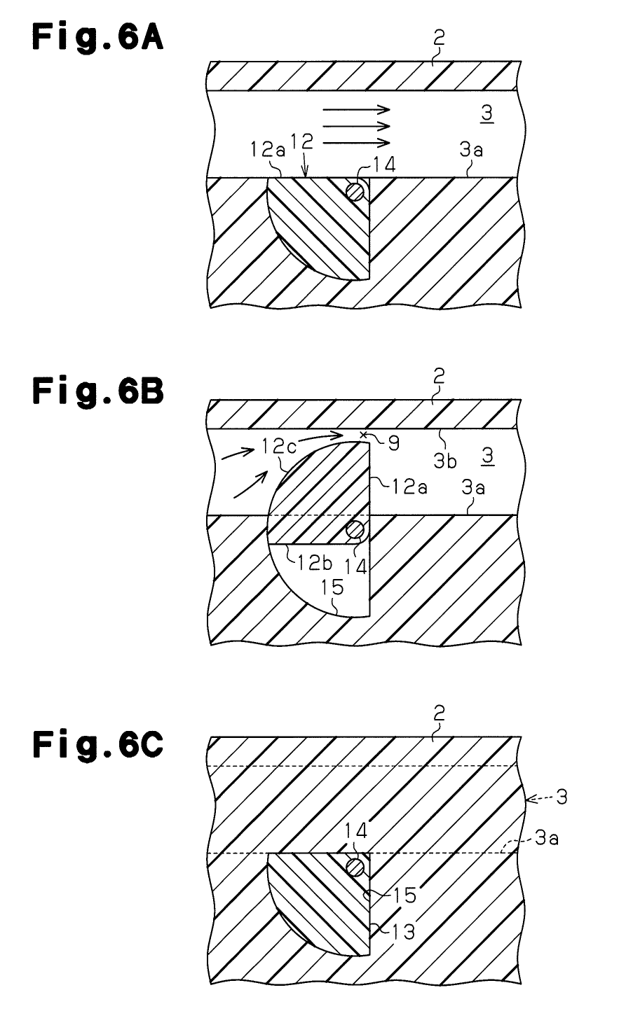

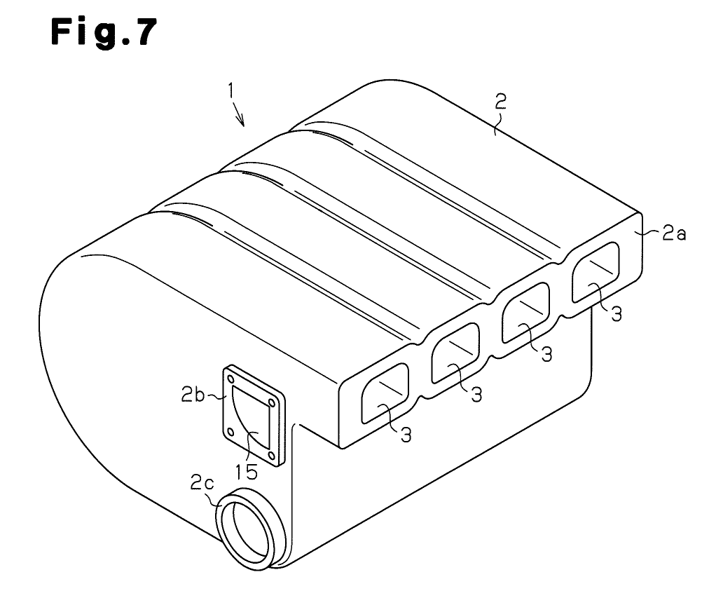

As shown in FIG. 6C, when the valve shaft 11 is received in the through hole 15, the partitioning portions 13 are non-rotatably fitted in the through hole 15. To seal the space between the wall defining the through hole 15 and each partitioning portion 13, liquid gasket may be used. Alternatively, a seal ring may be provided on the circumference of each partitioning portion 13.

As shown in FIGS. 6A to 6C, and 7, the through hole 15, which extends perpendicular to the intake passages 3, does not extend through each intake passage 3. The through hole 15 intersects each intake passage 3 in a manner to contact and communicate with the intake passage 3.

Referring to FIGS. 6A and 6B, the operation will be described below in which the position of the valve portions 12 in the through hole 15 is switched by rotation of the shaft portion 14, so that the intake passages 3 are opened and closed.

In a first position shown in FIG. 6A, each valve portion 12 is entirely accommodated in the recess in the floor 3a of the corresponding intake passage 3, such that the flat surface portion 12a of the valve portion 12 is flush with the floor 3a of the intake passage 3. At this time, the intake flow in each intake passage 3 is not hindered by the corresponding valve portion 12. That is, each intake passage 3 is fully open. When the shaft portion 14 is rotated clockwise from this state by 90°, most of each valve portion 12 projects from the recess of the floor 3a in the corresponding intake passage 3 as shown in FIG. 6B, and the valve portions 12 are in a second position, in which each valve portion 12 partly closes the corresponding intake passage 3. In this state, the intake flow in each intake passage 3 is limited to a space 9 between the valve portion 12 and the roof 3b of the intake passage 3. As a result, the intake flow in each intake passage 3 then flows in the corresponding intake port of the engine along the roof of the intake port. This promotes the occurrence of tumble flow in the combustion chambers of the engine.

When the valve portions 12 are switched from the first position to the second position, the arcuate surface portion 12c of each valve portion 12 slides in the recess of the corresponding intake passage 3 such that the arcuate surface portion 12c faces upstream in the intake passage 3. Therefore, the intake flow in each intake passage 3 is smoothly guided to the space 9 by the arcuate surface portion 12c of the corresponding valve portion 12, which prevents the intake flow in each intake passage 3 from being disturbed.

The second embodiment has the following advantage in addition to the advantages of the first embodiment.

The partitioning portions 13 are supported by the shaft portion 14 to be rotatable about the shaft portion 14, which is integrated with the valve portions 12. Thus, the valve portions 12 and the shaft portion 14 rotate integrally with each other relative to the partitioning portions 13. Since the area in which the shaft portion 14 contacts each partitioning portion 13 is small, the frictional resistance is small. This allows the shaft portion 14 to rotate smoothly, thereby facilitating the switching of the position of the valve portions 12.

The above described embodiments may be modified as follows.

In the first embodiment, the sealing member 8 provided on the circumference of each partitioning portion 6 does not need to be made of synthetic resin, but may be made of metal. In this case, each sealing member 8 may be integrated with the corresponding partitioning portion 6 through the insert molding.

In the first embodiment, each partitioning portion 6 does not need to be solid. To reduce the weight of the partitioning portions 6, a recess may be formed in the circumference of each partitioning portion 6.

In the first embodiment, the valve portions 5, the partitioning portions 6, and the shaft portions 7 do not need to be integrally formed of a synthetic resin. The valve shaft 4 may be formed by integrating the metal shaft portion 7 with the resin valve portions 5 and partitioning portions 6 through the insert molding.

In the second embodiment, each partitioning portion 13 does not need to be solid. To reduce the weight of the partitioning portions 13, the partitioning portion 13 may be formed by hollow half bodies.

In the first and second embodiments, the intake passages 3 do not need to have a semicircular cross section, but may have an oblong, ellipsoidal, or circular cross section.

In the first and second embodiments, the number of intake passages 3 formed in the casing 2 is not limited to four, but may be three or six in correspondence with the number of cylinders of the engine.

1. An integrated valve device for an intake manifold, the device comprising:
a casing having a plurality of intake passages each connected to an intake port of an internal combustion engine and a through hole extending perpendicular to the intake passages; and
a valve shaft received in the through hole,
wherein the valve shaft includes a plurality of valve portions, each valve portion being arranged to correspond to one of the intake passages, and wherein the valve portions are switchable between a first position, where each valve portion fully opens the corresponding intake passage, and a second position, where each valve portion partly blocks the corresponding intake passage.

2. The device according to claim 1, wherein a recess is formed in a wall defining each intake passage, and wherein, when in the first position, each valve portion is entirely accommodated in the corresponding recess, and when in the second position, each valve portion projects from the corresponding recess.

3. The device according to claim 2, wherein the valve shaft includes a shaft portion, and wherein, by rotating integrally with the shaft portion, the valve portions are switched between the first position and the second position.

4. The device according to claim 1, wherein the valve shaft includes partitioning portions located on both sides of each valve portion.

5. The device according to claim 3, wherein the valve shaft includes partitioning portions located on both sides of each valve portion.

6. The device according to claim 5, wherein each valve portion is integrally formed with the partitioning portions on the sides thereof.

7. The device according to claim 2, wherein each valve portion has an arcuate surface portion, and wherein, when the valve portions are in the second position, the arcuate surface portion of each valve portion faces upstream in the corresponding intake passage.

8. The device according to claim 2, wherein each valve portion has a flat surface portion, and wherein, when the valve portions are in the first position, the flat surface portion of each valve portion is flush with the wall in the corresponding intake passage.

9. The device according to claim 6, wherein the shaft portion is integrated with one of the partitioning portions.

10. The device according to claim 6, wherein each valve portion and the partitioning portions on the sides thereof are integrally formed of synthetic resin.

11. The device according to claim 4, wherein the partitioning portions are supported by the shaft portion to be rotatable about the shaft portion.

12. The device according to claim 2, wherein each valve portion has an outer shape defined by two intersecting flat surface portions and an arcuate surface portion connecting the flat surface portions to each other, and has a sectoral cross-sectional shape, wherein, when the valve portions are in the second position, the arcuate surface portion of each valve portion faces upstream in the corresponding intake passage.

13. The device according to claim 12, wherein, when the valve portions are in the first position, one of the flat surface portions of each valve portion is flush with the wall in the corresponding intake passage.
